(19) United States
(12) Patent Application Publication
(10) Pub. No.: US 2022/0230641 A1
(43) Pub. Date: Jul. 21, 2022

(54) SPEECH RECOGNITION SYSTEMS AND METHODS

(71) Applicant: Kabushiki Kaisha Toshiba, Tokyo (JP)

(72) Inventor: Cong-Thanh DO, Cambridge (GB)

(73) Assignee: Kabushiki Kaisha Toshiba, Tokyo (JP)

(21) Appl. No.: 17/403,786

(22) Filed: Aug. 16, 2021

(30) Foreign Application Priority Data
Jan. 20, 2021 (GB) 2100772.9

(51) Int. Cl. G10L 15/26; G10L 15/06; G10L 15/02; G10L 15/16

(52) U.S. Cl. CPC G10L 15/26; G10L 15/063; G10L 2015/0635; G10L 15/16; G10L 15/02

(57) ABSTRACT

A computer-implemented method for adapting a first speech recognition machine-learning model to utterances having one or more attributes, including: receiving an unlabelled utterance having the one or more attributes; generating a first transcription of the unlabelled utterance; generating a second transcription of the unlabelled utterance, wherein the second transcription is different from the first transcription; processing, by the first speech recognition machine-learning model, the one or more unlabelled utterances to derive posterior probabilities for the first transcription and the second transcription; and updating parameters of the first speech recognition machine-learning model in accordance with a loss function based on the derived posterior probabilities for the first transcription and the second transcription.

### FIELD

Embodiments described herein are concerned with speech recognition methods and systems, and methods for the training thereof.

### BACKGROUND

Speech recognition methods and systems receive speech audio and recognise the content of such speech audio, e.g. the textual content of such speech audio. Previous speech recognition systems include hybrid systems, and may include an acoustic model (AM), pronunciation lexicon and language model (LM) to determine the content of speech audio, e.g. decode speech. Earlier hybrid systems utilized Hidden Markov Models (HMMs) or similar statistical methods for the acoustic model and/or the language model. Later hybrid systems utilize neural networks for at least one of the acoustic model and/or the language model. These systems may be referred to as deep speech recognition systems. Speech recognition systems with end-to-end architectures have also been introduced. In these systems, the acoustic model, pronunciation lexicon and language model can be considered to be implicitly integrated into a neural network.

### BRIEF DESCRIPTION OF FIGURES

FIG. 1A is an illustration of a voice assistant system in accordance with example embodiments;

FIG. 1B is an illustration of a speech transcription system in accordance with example embodiments;

FIG. 1C is a flow diagram of a method for performing voice assistance in accordance with example embodiments;

FIG. 1D is a flow diagram of a method for performing speech transcription in accordance with example embodiments;

FIG. 2 is a flow diagram of a method for adapting a speech recognition machine-learning model using unlabelled utterances in accordance with example embodiments;

FIG. 3A is a flow diagram of a method for adapting two speech recognition machine-learning models using labelled utterances in accordance with example embodiments;

FIG. 3B is a flow diagram for adapting a speech recognition machine-learning model using labelled utterances in accordance with example embodiments;

FIG. 4 is a flow diagram of a method for performing speech recognition in accordance with example embodiments;

FIG. 5 is a block diagram of a system for supervised adaption of speech recognition machine-learning models in accordance with example embodiments;

FIG. 6 is a block diagram of a system for semi-supervised adaptation of a speech recognition machine-learning model using unlabelled and labelled utterances in accordance with example embodiments;

FIG. 7 is a schematic diagram of computing hardware using which example embodiments may be implemented;

FIG. 8A is a block diagram of a system used for supervised adaptation of speech recognition machine-learning models in an experiment; and

FIG. 8B is a block diagram of a system used for semi-supervised adaptation of speech recognition machine-learning models in the experiment.

### DETAILED DESCRIPTION

In a first embodiment, a computer-implemented method for adapting a first speech recognition machine-learning model to utterances having one or more attributes is provided. The method comprises: receiving an unlabelled utterance having the one or more attributes; generating a first transcription of the unlabelled utterance; generating a second transcription of the unlabelled utterance, wherein the second transcription is different from the first transcription; processing, by the first speech recognition machine-learning model, the unlabelled utterance to derive posterior probabilities for the first transcription and the second transcription; and updating parameters of the first speech recognition machine-learning model in accordance with a loss function based on the derived posterior probabilities for the first transcription and the second transcription.

The provided method adapts a speech recognition machine-learning model to speech having one or more attributes. The adapted speech recognition machine-learning model can better recognise the content of speech having one or more attributes. Due to the improvement in the recognition of the speech content, the content of speech having the one or more attributes can be more accurately transcribed into text and/or a correct command can be more frequently performed based on the content, e.g. the song indicated by a user may be recognised and hence played more frequently. A particular advantage of the provided method that it facilitates the adaptation and hence these improvements using unlabelled utterances, e.g. speech audio without transcriptions. Thus, it is possible to adapt the speech recognition machine-learning model without or with a limited number of human transcriptions, which are time consuming and expensive to provide. The adaptation of the speech recognition machine-learning model without, or with a limited number of, human transcriptions is facilitated by the use of at least two computer generated transcriptions in adaptation of the model. Using at least two computer generated transcriptions reduces the impact of errors in each of these computer generated transcriptions Therefore, speech recognition machine-learning models adapted using at least two computer generated transcriptions for each unlabelled utterance better recognise speech content having the attribute(s), whereas, if a single computer generated transcription were to be used for adaptation, the impact of the errors therein may result in a speech recognition machine-learning model that is worse at recognising the content of speech having the one or more attributes than the speech recognition machine-learning model prior to adaptation.

Furthermore, in situ adaptation of the speech recognition machine-learning model may be facilitated as, given the time consuming nature of providing human transcriptions, users of a speech recognition machine-learning model may be unwilling to do so or may only be willing to provide a very small quantity of these, such that the speech recognition machine-learning model cannot be well adapted to attributes specific to the user or context, e.g. their particular voice or environment. However, as unlabelled utterances can be recorded, with the user's consent, in normal use of the speech recognition machine-learning model, adaptation to these user or context specific attributes can be performed without, or at least with less, manual effort by the user.

The first transcription may be of a plurality of utterances. The second transcription may be of the same plurality of utterances.

The second transcription may differ from the first transcription in that the first transcription is generated by a second speech recognition machine-learning model while the second transcription generated by a different third speech recognition machine-learning model.

The second speech recognition machine-learning model may have been trained using a first type of feature, and the third speech recognition machine-learning model may have been trained using a different second type of features.

The first transcription may be generated by a second speech recognition machine-learning model trained using a first type of features. The second transcription may be generated by a third speech recognition machine-learning model trained using a second type of features.

The first type of features may be filter-bank features. The second type of features may be subband temporal envelope features.

The first transcription may be the 1-best hypothesis of the second speech recognition machine-learning model. The second transcription may be the 1-best hypothesis of the third speech recognition machine-learning model.

The provided method may further comprise: receiving one or more labelled utterances having the one or more attributes; deriving features of the first type from the one or more labelled utterances; updating parameters of the second machine-learning model using the derived features of the first type and labels of the one or more labelled utterances; deriving features of the second type from the one or more labelled utterances; and updating parameters of the third machine-learning models using the derived features of the second type and the labels of the one or more labelled utterances.

The first transcription and the second transcription may be N-best transcriptions generated by a second speech recognition machine-learning model. The second transcription may differ from the first transcription in that the second transcription is for a different value of N than the first transcription.

The provided method may further comprise: receiving one or more labelled utterances having the one or more attributes; and updating the parameters of the first speech recognition machine-learning model using the one or more labelled utterances.

The one or more attributes may comprise the utterance having background noise of a given type.

The one or more attributes may including the utterance having background noise with one or more traits. The one or more traits may include or be based on the level of the background noise; the pitch of the background noise; the direction of the background noise; the timbre of the background noise; the sonic texture of the background noise; and/or the type of the background noise.

The one or more attributes may comprise the utterance having a given accent.

The one or more attributes may comprise the utterance being in a given domain.

The one or more attributes may comprise the utterance being by a given user.

The one or more attributes may comprise one or more properties of the voice speaking the utterance. The one or more properties may include the voice speaking the utterance being the voice of a given user. The one or more properties may include the voice speaking the utterance having a given accent.

The one or more attributes may comprise the utterance being recorded in a given environment.

The unlabelled utterances may have been artificially modified to have the one or more attributes.

The loss function may be a connectionist temporal classification loss function.

The connectionist temporal classification loss function may comprise a sum of a first connectionist temporal classification loss for the first transcription by a second connectionist temporal classification loss for the second hypothesis.

The first speech recognition machine-learning model may comprise a bidirectional long short-term memory neural network.

According to a second embodiment, there is provided a computer program, optionally stored on a non-transitory computer readable medium, which, when the program is executed by a computer cause the computer to carry out a method according to the first embodiment.

According to a third embodiment, there is provided a system for adapting a first speech recognition machine-learning model to utterances having one or more attributes. The system comprises one or more processors and one or more memories. The one or more processors are configured to perform a method according to the first embodiment.

According to a fourth embodiment, a computer-implemented method for speech recognition is provided. The method comprises: receiving one or more utterances having one or more attributes; recognising content of the one or more utterances using a speech recognition machine-learning model adapted to utterances having the one or more attributes according to a method according to the first embodiment; and executing a function based on the recognised content, wherein the executed function comprises at least one of text output, command performance, or spoken dialogue system functionality.

According to a fifth embodiment, there is provided a computer program, optionally stored on a non-transitory computer readable medium, which when the program is executed by a computer cause the computer to carry out a method according to the fourth embodiment.

According to a sixth embodiment, there is provided a system for performing speech recognition. The system comprises one or more processors and one or more memories. The one or more processors are configured to perform a method according to the fourth embodiment.

According to a seventh embodiment, there is provided a system for performing speech recognition. The system comprises one or more processors and one or more memories. The one or more processors are configured to: receive one or more utterances having one or more attributes; recognise content of the one or more utterances using a speech recognition machine-learning model adapted to utterances having the one or more attributes according to the method of any preceding claim; and execute a function based on the recognising content, wherein the executed function comprises at least one of text output or command performance.

The system for performing speech recognition may be a speech dialogue system or component thereof.

### Example Contexts

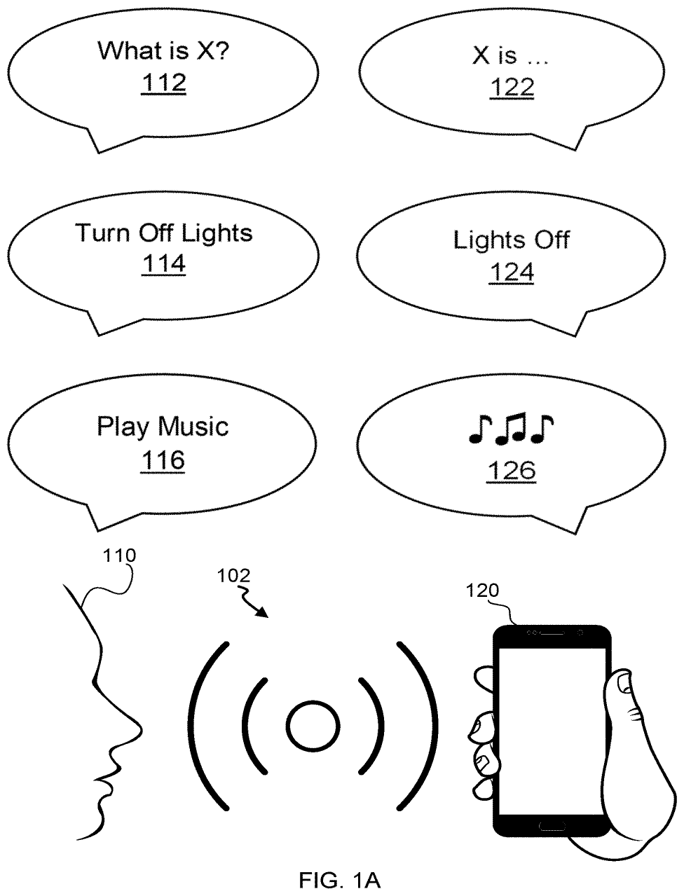

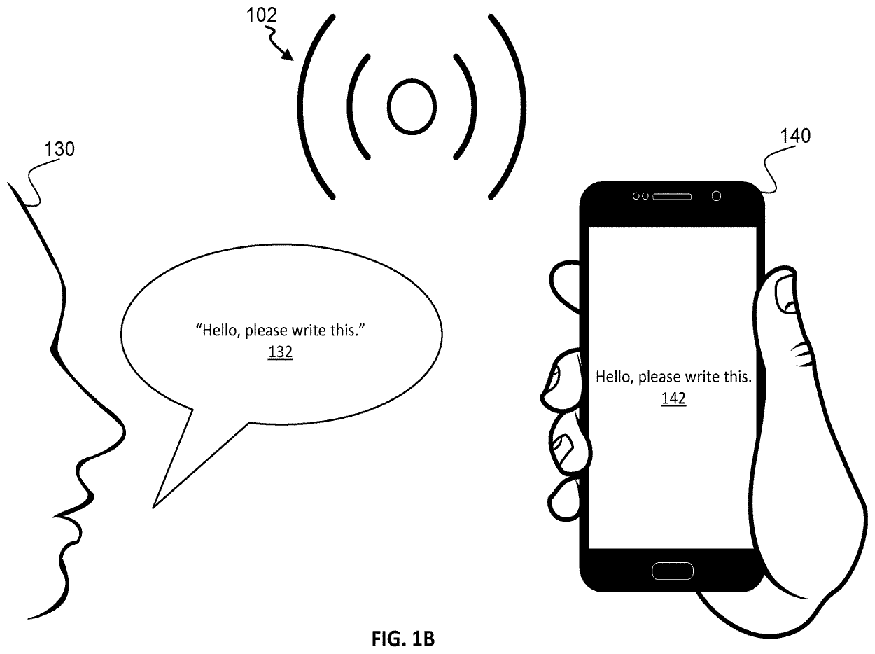

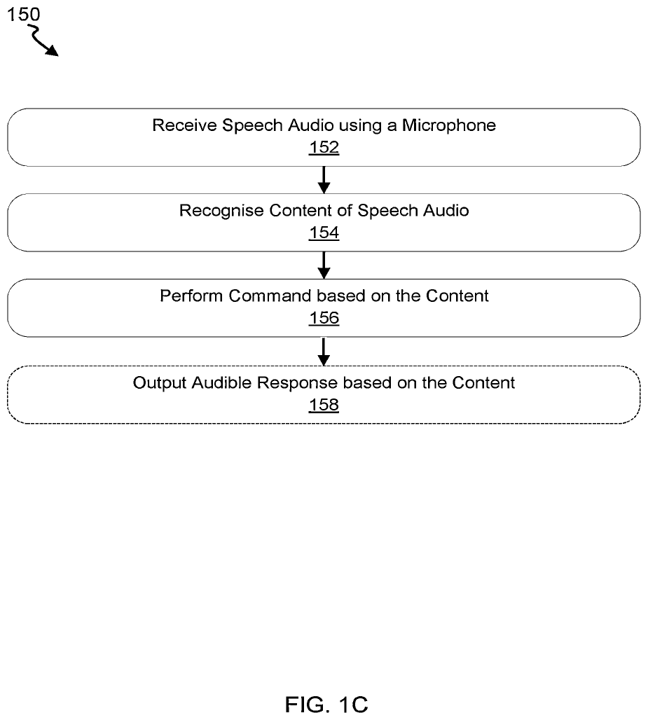

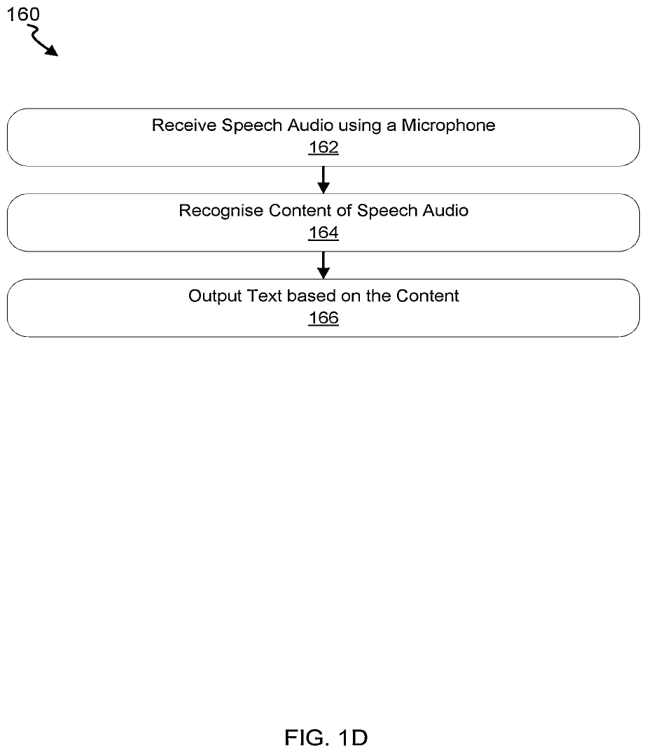

For the purposes of illustration, example contexts in which the subject innovations can be applied are described in relation to FIGS. 1A-1D. However, it should be understood that these are exemplary, and the subject innovations may be applied in any suitable context, e.g. any context in which speech recognition is applicable.

### Voice Assistant System

FIG. 1A is an illustration of a voice assistant system 120 in accordance with example embodiments.

The voice assistant system 120 may be or may be implemented using a smartphone, as is illustrated, or may be any other suitable computing device, e.g. a laptop computer, a desktop computer, a tablet computer, a games console, a smart hub, or a smart speaker.

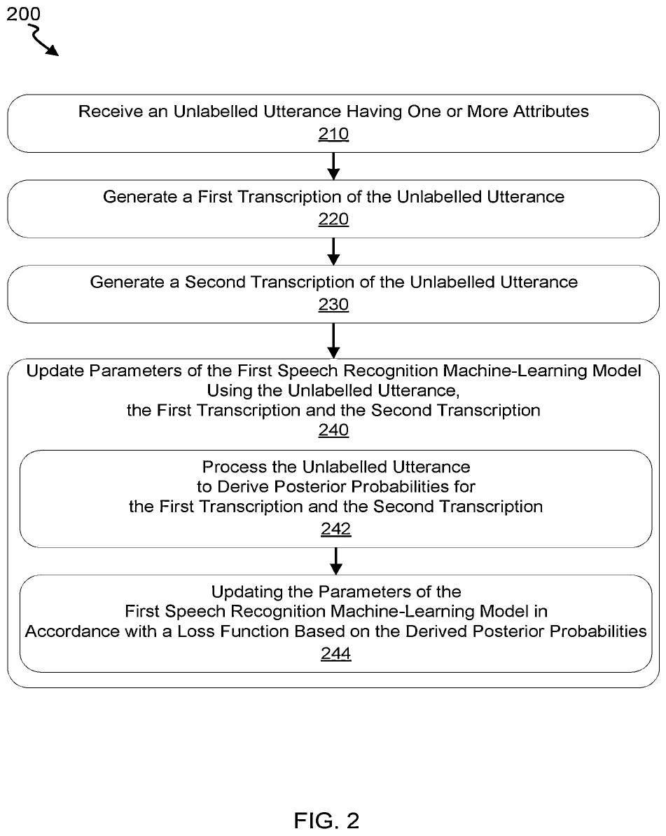

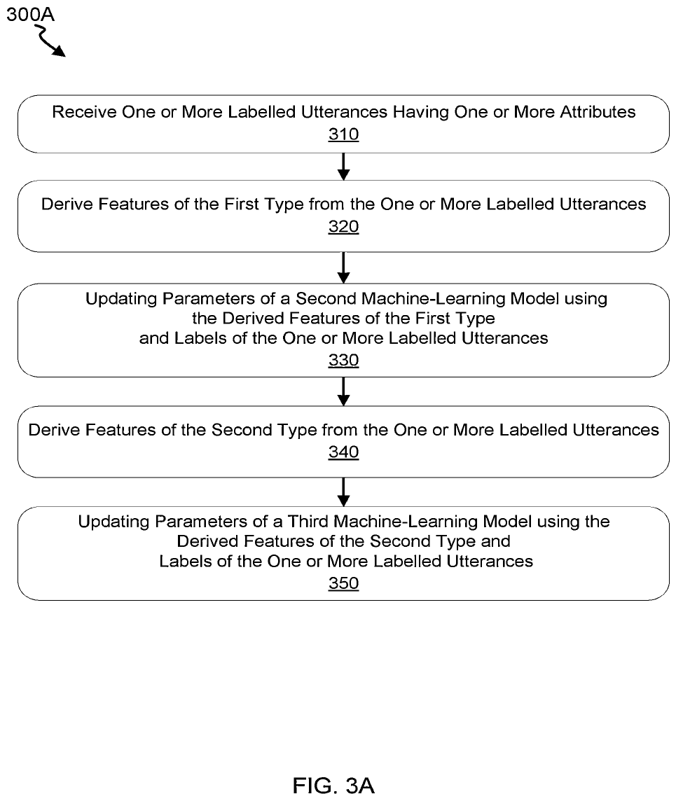

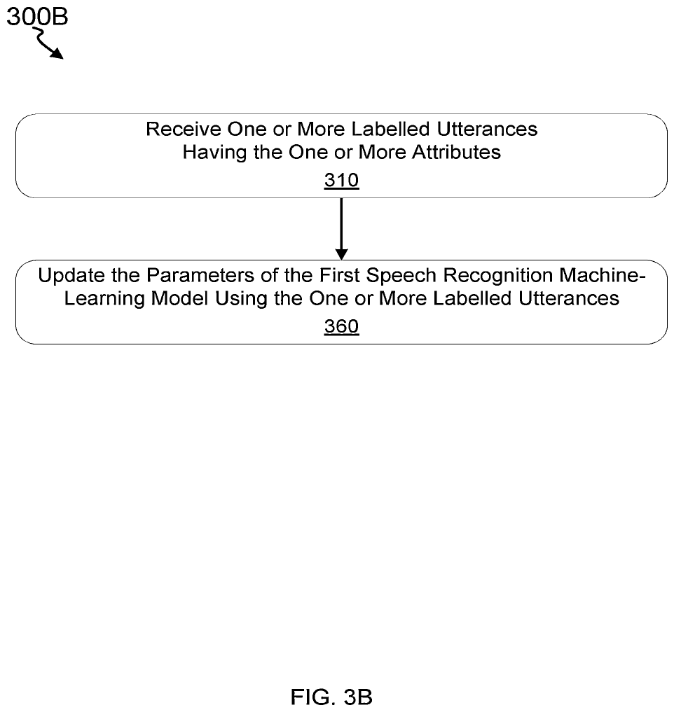

The environment within which the voice assistant system 120 operates may contain background noise 102. The background noise 102 may be background noise of a given type which may relate to the context in which the voice assistant system is being used. For example, the background noise 102 may be café noise, such as background chatter and eating noises; street noise, such as traffic noise; pedestrian area noise, such as footsteps; and/or bus noise, such as engine noise. The voice assistant system 120 may be adapted to operate in an environment including the background noise 102. The voice assistant system 120 may also be adapted to operate in an environment having given acoustic characteristics, e.g. sound absorptions, reflections and/or reverberations. The voice assistant system 120 may include a speech recognition machine-learning model which has been adapted to operate in an environment including the background noise and/or having given acoustic characteristics by the method described in relation to FIG. 2 and/or the method described in relation to FIG. 3A.

A user 110 may speak a command 112, 114, 116 to the voice assistant system 120. In response to the user 110 speaking the command 112, 114, 116, the voice assistant system 120 performs the command, which may include outputting an audible response. The voice of the user 110 speaking the command 112, 114, 116 may have one or more properties, e.g. the voice having a given accent or dialect, the voice being of a given user, the voice being said with a given emotion and/or the voice having a certain tone or timbre. The voice assistant system 120 may be adapted to operate with commands spoken with a voice having the one or more properties. The voice assistant system 120 may include a speech recognition machine-learning model which has been adapted to the voice or voices having the one or more properties by the method described in relation to FIG. 2 and/or the method described in relation to FIG. 3A.

To receive the spoken command 112, 114, 116, the voice assistant system 120 includes or is connected to a microphone. To output an audible response, the voice assistant system 120 includes or is connected to a speaker. The voice assistant system 120 may include functionality, e.g. software and/or hardware, suitable for recognising the spoken command, performing the command or causing the command to be performed, and/or causing a suitable audible response to be output. Alternatively or additionally, the voice assistant system 120 may be connected via a network, e.g. via the internet and/or a local area network, to one or more other system(s) suitable for recognising the spoken command, causing the command to be performed, e.g. a cloud computing system and/or a local server. A first part of the functionality may be performed by hardware and/or software of the voice assistant system 120 and a second part of the functionality may be performed by the one or more other systems. In some examples, the functionality, or a greater part thereof, may be provided by the one or more other systems where these one or more other systems are accessible over the network, but the functionality may be provided by the voice assistant system 120 when they are not, e.g. due to the disconnection of the voice assistant system 120 from the network and/or the failure of the one or more other systems. In these examples, the voice assistant system 120 may be able to take advantage of the greater computational resources and data availability of the one or more other systems, e.g. to be able to perform a greater range of command commands, to improve the quality of speech recognition, and/or to improve the quality of the audible output, while still being able to operate without a connection to the one or more other systems.

For example, in the command 112, the user 110 asks “What is X?”. This command 112 may be interpreted by the voice assistant system 120 as a spoken command to provide a definition of the term X. In response to the command, the voice assistant system 120 may query a knowledge source, e.g. a local database, a remote database, or another type of local or remote index, to obtain a definition of the term X. The term X may be any term for which a definition can be obtained. For example, the term X could be a dictionary term, e.g. a noun, verb or adjective; or an entity name, e.g. the name of a person or a business. When the definition has been obtained from the knowledge source, the definition may be synthesised into a sentence, e.g. a sentence in the form of “X is [definition]”. The sentence may then be converted into an audible output 112, e.g. using text-to-speech functionality of the voice assistant system 120, and output using the speaker included in or connected in the voice assistant system 120.

As another example, in the command 114, the user 110 says “Turn Off Lights”. The command 114 may be interpreted by the voice assistant system as a spoken command to turn off one or more lights. The command 114 may be interpreted by the voice assistant system 120 in a context sensitive manner. For example, the voice assistant system 120 may be aware of the room in which it is located and turn off the lights in that room specifically. In response to the command, the voice assistant system 120 may cause one or more lights to be turned off, e.g. cause one or more smart bulbs to no longer emit light. The voice assistant system 120 may cause the one or more lights to be turned off by directly interacting with the one or more lights, e.g. over a wireless connection, such as a Bluetooth connection, between the voice assistant system and the one or more lights; or by indirectly interacting with the lights, e.g. sending one or more messages to turn the lights off to a smart home hub or a cloud smart home control server. The voice assistant system 120 may also produce an audible response 124, e.g. a spoken voice saying ‘lights off’, confirming to the user that the command has been heard and understood by the voice assistant system 120.

As an additional example, in the command 116, the user 110 says “Play Music”. The command 116 may be interpreted by the voice assistant system as a spoken command to play music. In response to the command, the voice assistant system 120 may: access a music source, such as local music files or a music streaming service, stream music from the music source, and output the streamed music 126 from the speaker included in or connected to the voice assistant system 120. The music 126 outputted by the voice assistant system 120 may be personalised to the user 110. For example, the voice assistant system 120 may recognise the user 110, e.g. by the properties of the voice of user 110, or may be statically associated with the user 110, then resume the music previously played by the user 110 or play a playlist personalised to the user 110.

The voice assistant system 120 may be a spoken dialogue system, e.g. the voice assistant system 120 may be able to converse with the user 110 using text-to-speech functionality.

### Speech Transcription System

FIG. 1B is an illustration of a speech transcription system 140 in accordance with example embodiments.

The speech transcription system 140 may be or may be implemented using a smartphone, as is illustrated, or may be any other suitable computing device, e.g. a laptop computer, a desktop computer, a tablet computer, a games console, or a smart hub.

The environment within which the speech transcription system 140 operates may contain background noise 102. The background noise 102 may be background noise of a given type which may relate to the context in which the speech transcription system is being used. For example, the background noise 102 may be café noise, such as background chatter and eating noises; street noise, such as traffic noise; pedestrian area noise, such as footsteps; and/or bus noise, such as engine noise. The speech transcription system 140 may be adapted to operate in an environment including the background noise 102. The speech transcription system 140 may also be adapted to operate in an environment having given acoustic characteristics, e.g. sound absorptions, reflections and/or reverberations. The speech transcription system 140 may include a speech recognition machine-learning model which has been adapted to operate in an environment including the background noise and/or having given acoustic characteristics by the method described in relation to FIG. 2 and/or the method described in relation to FIG. 3A.

A user 130 may speak to the speech transcription system 140. In a response to the user speaking, the speech transcription system 140 produces a textual output 142 representing the content of the speech 132. The voice of the user 130 may have one or more properties, e.g. the voice having a given accent or dialect, the voice being the voice of a given user, the voice being said with a given emotion and/or the voice having a certain tone or timbre. The speech transcription system 140 may be adapted to operate with commands spoken with a voice having the one or more properties. The voice assistant system may include a speech recognition machine-learning model which has been adapted to the voice or voices having the one or more properties by the method described in relation to FIG. 2 and/or the method described in relation to FIG. 3A.

To receive the speech, the speech transcription system 140 includes or is connected to a microphone. The speech transcription system 140 may include software suitable for recognising the content of the speech audio and outputting text representing the content of the speech, e.g. transcribe the content of the speech. Alternatively or additionally, the speech transcription system 140 may be connected via a network, e.g. via the internet and/or a local area network, to one or more other system(s) suitable for recognising the content of the speech audio and outputting text representing the content of the speech. A first part of the functionality may be performed by hardware and/or software of the speech transcription system 140 and a second part of the functionality may be performed by the one or more other systems. In some examples, the functionality, or a greater part thereof, may be provided by the one or more other systems where these one or more other systems are accessible over the network, but the functionality may be provided by the speech transcription system 140 when they are not, e.g. due to the disconnection of the speech transcription system 140 from the network and/or the failure of the one or more other systems. In these examples, the speech transcription system 140 may be able to take advantage of the greater computational resources and data availability of the one or more other systems, e.g. to improve the quality of speech transcription, while still being able to operate without a connection to the one or more other systems.

The outputted text 142 may be displayed on a display included in or connected to the speech transcription system 140. The outputted text may be input to one or more computer programs running on the speech transcription system 140, e.g. a messaging app.

### Voice Assistance Method

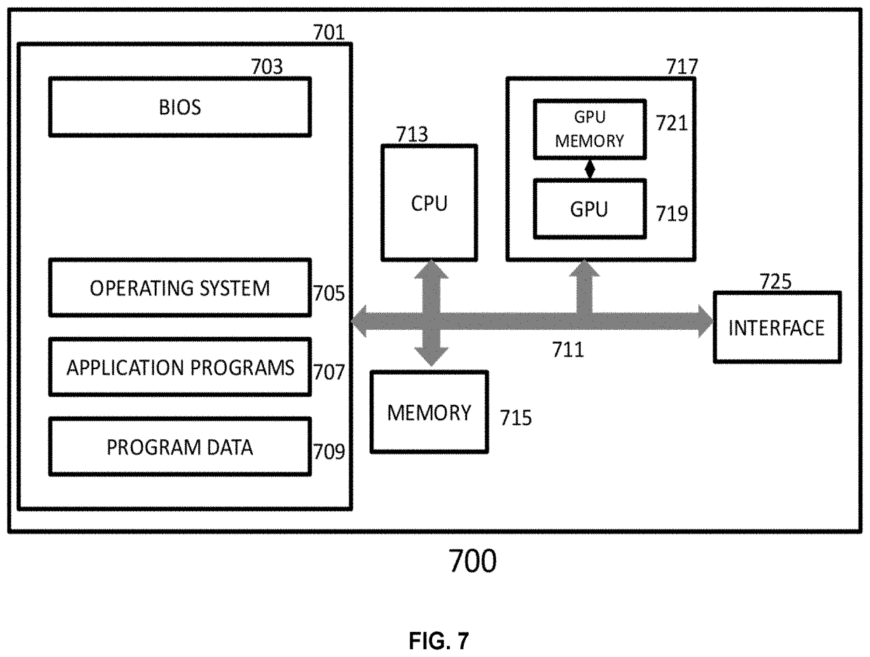

FIG. 1C is a flow diagram of a method 150 for performing voice assistance in accordance with example embodiments. Optional steps are indicated by dashed lines. The example method 150 may be implemented as one or more computer-executable instructions executed by one or more computing devices, e.g. the hardware 700 described in relation to FIG. 7. The one or more computing devices may be or include a voice assistant system, e.g. the voice assistant system 120, and/or may be integrated into a multi-purpose computing device, such as a smartphone, desktop computer, laptop computer, smart hub, or games console.

In step 152, speech audio is received using a microphone, e.g. a microphone of a voice assistant system or a microphone integrated into or connected to a multi-purpose computing device. The speech audio may have one or more attributes, e.g. the speech audio may have background noise, as described in relation to background noise 102; or voice captured in the speech audio may have one or more properties, e.g. be in a given accent or dialect. As the speech audio is received, the speech audio may be buffered in a memory, e.g. a memory of a voice assistant system or a multi-purpose computing device.

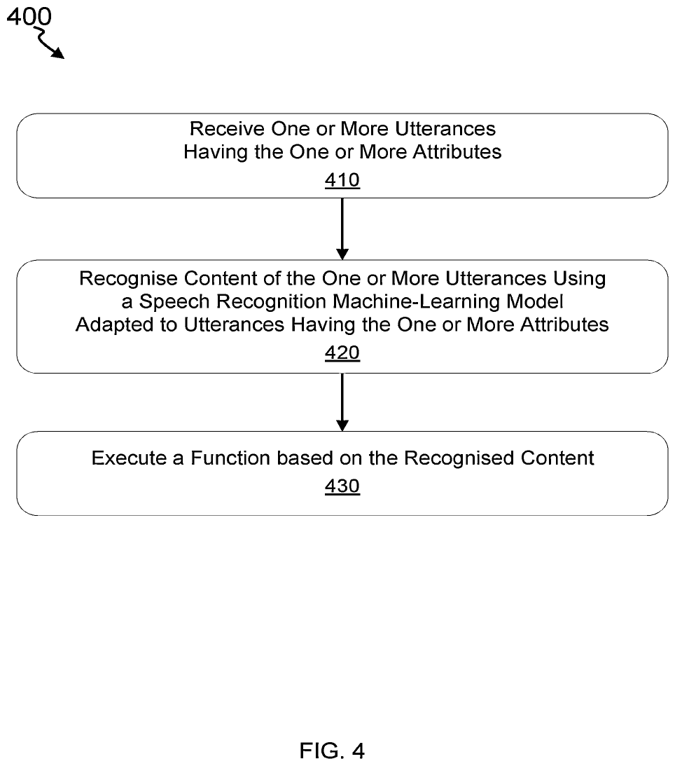

In step 154, the content of the speech audio is recognised. The content of speech audio may be recognised using methods described herein, e.g. the method 400 of FIG. 4. The recognised content of the speech audio may be text, syntactic content, and/or semantic content. The recognised content may be represented using one or more vectors. Additionally, e.g. after further processing, or alternatively, the recognised content may be represented using one or more tokens. Where the recognised content is text, each token and/or vector may represent a character, a phoneme, a morpheme or other morphological unit, a word part, or a word.

In step 156, a command is performed based on the content of the speech audio. The performed command may be, but is not limited to, any of the commands 112, 114, 116 described in relation to FIG. 1A, and may be performed in the manner described. The command to be performed may be determined by matching the recognised content to one or more command phrases or command patterns. The match may be approximate. For example, for the command 114 which turns off lights, the command may be matched to phrases containing the words “lights” and “off”, e.g. “turn the lights off” or “lights off”. The command 114 may also be matched to phrases that approximately semantically correspond to “turn the lights off”, such as “close the lights” or “lamp off”.

In step 158, an audible response is output based on the content of the speech audio, e.g. using a speaker included in or connected to a voice assistant system or multi-purpose computing device. The audible response may be any of the audible responses 122, 124, 126 described in relation to FIG. 1A, and may be produced in the same or a similar manner to that described. The audible response may be a spoken sentence, word or phrase; music; or another sound, e.g. a sound effect or alarm. The audible response may be based on the content of the speech audio in itself and/or may be indirectly based on the content of the speech audio, e.g. be based on the command performed, which is itself based on the content of the speech audio.

Where the audible response is a spoken sentence, phrase or word, outputting the audible response may include using text-to-speech functionality to transform a textual, vector or token representation of a sentence, phrase or word into spoken audio corresponding to the sentence, phrase or word. The representation of the sentence or phrase may have been synthesised on the basis of the content of the speech audio in itself and/or the command performed. For example, where the command is a definition retrieval command in the form “What is X?”, the content of the speech audio includes X, and the command causes a definition, [def], to be retrieve from a knowledge source. A sentence in the form “X is [def]” is synthesised, where X is from the content of the speech audio and [def] is content retrieved from a knowledge source by the command being performed.

As another example, where the command is a command causing a smart device to perform a function, such as a turn lights off command that causes one or more smart bulbs to turn off, the audible response may be a sound effect indicating that the function has been or is being performed.

As indicated by the dashed lines in the figures, the step of producing an audible response is optional and may not occur for some commands and/or in some implementations. For example, in the case of a command causing a smart device to perform a function, the function may be performed without an audible response being output. An audible response may not be output, because the user has other feedback that the command has been successfully completed, e.g. the light being off.

### Speech Transcription Method

FIG. 1D is a flow diagram of a method 160 for performing speech transcription in accordance with example embodiments. The example method 160 may be implemented as one or more computer-executable instructions executed by one or more computing devices, e.g. the hardware 700 described in relation to FIG. 7. The one or more computing devices may be a computing device, such as a desktop computer, laptop computer, smartphone, smart television, or games console.

In step 162, speech audio is received using a microphone, e.g. a microphone integrated into or connected to a computing device. The speech audio may have one or more attributes, e.g. the speech audio may have background noise, as described in relation to background noise 102; or voice captured in the speech audio may have one or more properties, e.g. be in a given accent or dialect. As the speech audio is received, the speech audio may be buffered in a memory, e.g. a memory of a computing device.

In step 164, the content of the speech audio is recognised. The content of speech audio may be recognised using methods described herein, e.g. the method 400 of FIG. 4. The recognised content may be represented using one or more vectors. Additionally, e.g. after further processing, or alternatively, the recognised content may be represented using one or more tokens. Where the recognised content is text, each token and/or vector may represent a character, a phoneme, a morpheme or other morphological unit, a word part, or a word.

In step 166, text is output based on the content of the speech audio. Where the recognised content of the speech audio is textual content, the outputted text may be the textual content, or may be derived from the textual content as recognised. For example, the textual content may be represented using one or more tokens, and the outputted text may be derived by converting the tokens into the characters, the phonemes, the morphemes or other morphological units, word parts, or words that they represent. Where the recognised content of the speech audio is or includes semantic content, output text having a meaning corresponding to the semantic content may be derived. Where the recognised content of the speech audio is or includes syntactic content, output text having a structure, e.g. a grammatical structure, corresponding to the syntactic content may be derived.

The outputted text may be displayed. The outputted text may be input to one or more computer programs, such as a messaging application. Further processing may be performed on the outputted text. For example, spelling and grammar errors in the outputted text may be highlighted or corrected. In another example, the outputted text may be translated, e.g. using a machine translation system.

### Speech Recognition Machine-Learning Model Adaptation Using Unlabelled Utterances

FIG. 2 is a flow diagram of a method 200 for adapting a first speech recognition machine-learning model using unlabelled utterances in accordance with example embodiments. The example method may be implemented as one or more computer-executable instructions executed by one or more computing devices, e.g. the hardware 700 described in relation to FIG. 7.

The first speech recognition machine-learning model may be a speech recognition neural network. The speech recognition neural network may be an end-to-end speech recognition neural network, or may include an acoustic model, a pronunciation lexicon, and a language model. The speech recognition neural network may include one or more convolutional neural network (CNN) layers. The speech recognition neural network may include one or more recurrent layers, e.g. long short-term memory (LSTM) layers and/or gradient recurrent unit (GRU) layers. The one or more recurrent layers may be bidirectional recurrent layers, e.g. bidirectional LSTM (BLSTM) layers. As an alternative, the speech recognition neural network may be a transformer network including one or more feed-forward neural network layers and one or more self-attention neural network layers.

In an example, the first speech recognition machine-learning model includes an initial layers of the visual geometry group (VGG) net architecture (deep CNN) followed by a 6-layer pyramid BLSTM (a BLSTM with subsampling). The deep CNN has six layers which includes two consecutive 2D convolutional layers followed by one 2D max-pooling layer, then another two 2D convolutional layers followed by one 2D max-pooling layer. The 2D filters used in the convolutional layers have the same size of 3×3. The max-pooling layers have patch of 3×3 and stride of 2×2. The 6-layer BLSTM has 1024 memory blocks in each layer and direction, and linear projection is followed by each BLSTM layer. The subsampling factor performed by the BLSTM is 4.

The first speech recognition machine-learning model may be configured to receive utterances in the form of acoustic features. These acoustic features may be acoustic features of a first type. The acoustic features may be filter-bank features. For example, the acoustic features may be 40-dimensional log-Mel filter-bank (FBANK) features. The FBANK features may be augmented with 3 dimensional pitch features. Delta and acceleration features may be appended to these features. Alternatively, the acoustic features may be subband temporal envelope features (STE) features, e.g. 40-dimensional STE features. The STE features may be augmented with 3-dimensional pitch features. Delta and acceleration features may be appended to the STE features. Subband temporal envelope features track energy peaks in perceptual frequency bands which reflect the resonant properties of the vocal tract.

The first speech recognition machine-learning model may have been trained using a plurality of labelled utterances. The plurality of labelled utterances or a majority of the plurality of labelled utterances may not have one or more attributes specified below, e.g. the plurality of labelled utterances may be a generic set of utterances. Each of the plurality of labelled utterances includes an utterance and a respective transcription of the utterance. The respective transcription may include one or more characters. For the training of the first speech recognition machine-learning model, the utterances of each of the plurality of labelled utterances may be provided as acoustic features of the first type.

The first speech recognition machine-learning model may have been trained by updating parameters, e.g. weights, of the first speech recognition machine-learning model in accordance with a loss function based on posterior probabilities derived by the first speech recognition machine-learning model for the one respective transcription for each utterance of the plurality of labelled utterances. The updating of the parameters may be performed by using a gradient descent method directed at minimising the loss function, e.g. stochastic gradient descent, in combination with a backpropagation algorithm.

An example of a loss function that may be used is the connectionist temporal classification (CTC) loss function. The CTC loss function may be defined as follows. Each utterance may include T frames with acoustic features, e.g. acoustic features of the first type, provided for each frame. Given a T-length acoustic feature vector sequence for an utterance, e.g. acoustic features of the first type for each frame, X={xₜ∈ [symbol] ^{d}|t=1, . . . , T}, where xₜ is a d-dimensional feature vector at frame t, and a transcription C={cₗ∈ [symbol] |l=1, . . . , L} which consists of L characters, where [symbol] is a set of distinct characters, the CTC loss function L_{CTC} may be defined as follows:

L_{CTC}=−log P_{θ}(C|X)

where θ are the parameters of the speech learning machine-learning model, e.g. weights of the speech learning machine-learning neural network. Where X are acoustic features for a given utterance of the plurality of the labelled utterances, the transcription C is the respective transcription of the utterance.

The CTC loss function may be computed by introducing a CTC path which forces the output character sequence to have the same length as the input feature sequence by adding blank as an additional label, e.g. character, and allowing repetition of labels, e.g. character. The CTC loss L_{CTC} may be computed by integrating over all possible CTC paths [symbol] ⁻¹ (C) expanded from C:

$${L}_{CTC} = - log {P}_{θ} ( C \vert X ) - log {\sum }_{a ∈ {B}^{- 1} ( C )} {P}_{θ} ( a \vert X )$$

While the CTC loss is described above, it should be noted that other suitable loss functions may be used, e.g. recurrent neural network—transducer loss, lattice-free maximum mutual information, or cross-entropy loss.

In step 210, an utterance having one or more attributes is received. The unlabelled utterance may be one or more pieces of speech. Each of the one or more pieces of speech may be a continuous piece of speech. Each of the one or more pieces of speech may begin with a pause and end with a pause or a change of speaker. The utterance may be received as audio data, e.g. a compressed or uncompressed audio stream, or a compressed or uncompressed audio file.

The one or more attributes may include the utterance being in a given domain. The domain may be an area of expertise, e.g. medicine, law, or digital technology. The domain may be a subject, e.g. science, history, geography or literature. The domain may be a use case, e.g. home assistance, office assistance, or manufacturing assistance.

The one or more attributes may include the utterance being by a given user.

The one or more attributes may include one or more properties of the voice speaking the utterance.

The one or more properties may include the voice speaking the utterance being the voice of a given user. Utterances spoken by a given user may have particular vocal characteristics, e.g. have a given accent, be in a given dialect, have a given rhythm, and/or have a given timbre

The one or more properties may include the voice speaking the utterance having a given accent. For example, the accent may be an accent associated with a given country, region, or urban area, and/or an accent associated with a given community, where the given community may be geographically localised or may be geographically distributed.

The one or more attributes may include the utterance being recorded in a given environment. Utterances that have been recorded in the given environment may have particular acoustic characteristics, e.g. the particular acoustic characteristics may reflect the amount of sound absorption, reverberation and/or reflection within the environment. These utterances may also include background noise that is commonly encountered in the environment.

The one or more attributes may include the utterance having background noise of a given type. For example, the background noise may be café noise, such as background chatter and eating noises; street noise, such as traffic noise; pedestrian area noise, such as footsteps; bus noise, such as engine noise; airport noise, such as planes taking off; babble; car noise; restaurant nose; street noise; or train noise.

The one or more attributes may include the utterance having background noise with one or more traits. The one or more traits may include the background noise being of a specified noise level, above a specified noise level, below a specified noise level or of a noise level within a specified range. A noise level may be specified as a noise volume, by a signal-to-noise ratio of the utterance, or using any other suitable metric for quantifying noise. The one or more traits may include the background noise being of a specified pitch, above a specified pitch, below a specified pitch, or of a pitch within a specified range. The one or more traits may include the background noise being from one specified directions and/or direction ranges relative to the device capturing the background noise. The one or more traits may include the background noise having a specified timbre. The one or more traits may include the background noise having a particular sonic texture. The one or more traits may include the background noise being of a given type.

The unlabelled utterance may naturally have the one or more attributes, or may have been artificially modified to have the one or more attributes. For example, where the one or more attributes include the utterance having background noise of a given type, an utterance without the background noise of the given type may have been combined with, e.g. overlaid on, a recording or simulation of background noise of the given type. As another example, where the one or more attributes include the utterance being recorded in a given environment, an utterance that has been recorded in another environment, e.g. a studio environment, may be modified to simulate an utterance being recorded in the given environment. The modifications may include transformations of the acoustics of the utterance to reflect the different acoustic characteristics of the given environment to the another environment and/or combining, e.g. overlaying, the utterance with recording or simulation of noise encountered in the given environment.

In step 220, a first transcription of the unlabelled utterance is generated.

The first transcription may be generated by a second speech recognition machine-learning model. The second speech recognition machine-learning model may be of any of the types described in relation to the first speech recognition machine-learning model. The second speech recognition machine-learning model may be configured to receive acoustic features of the first type, e.g. FBANK features. The second speech recognition machine-learning model may have the same architecture as the first speech recognition machine-learning model. The second speech recognition machine-learning model have been trained in the same manner and/or using the same training data as the first speech recognition machine-learning model. The second speech recognition machine-learning model may have undergone supervised adaptation, e.g. it may been adapted to utterances having the one or more attributes using a labelled plurality of utterances having the one or more attributes, as is described in relation to FIG. 3A.

The first transcription may be generated by decoding the utterance using the second speech recognition machine-learning model. The decoding may be performed using a beam search algorithm. The beam width may be set to any suitable value, e.g. 20. The beam search algorithm may be a one-pass beam search algorithm. CTC score may be used in the beam search algorithm. The first transcription may be an N-best hypothesis generated by the decoding, e.g. the 1-best hypothesis.

In step 230, a second transcription of the unlabelled utterance is generated.

The second transcription may be generated by a third speech recognition machine-learning model. The third speech recognition machine-learning model may be of any of the types described in relation to the first speech recognition machine-learning model. The third speech recognition machine-learning model may configured to receive acoustic features of a type other than the first type. For example, if the first type of acoustic features are FBANK features then the third speech recognition machine-learning model may be configured to receive STE features, or vice versa. The third speech recognition machine-learning model may have the same architecture as the first speech recognition machine-learning model and/or the second speech recognition machine-learning model. The third speech recognition machine-learning model may have been trained in the same manner and/or using the same or similar training data as the first speech recognition machine-learning. For example, the third speech recognition machine-learning model may have been trained using the same plurality of labelled utterances but with the acoustic features being of the type other than the first type, e.g. STE features instead of FBANK features, or vice versa. The third speech recognition machine-learning model may have undergone supervised adaptation, e.g. it may have been adapted to utterances having the one or more attributes using a labelled plurality of utterances having the one or more attributes, as is described in relation to FIG. 3A.

The second transcription may be generated by decoding the unlabelled utterance using the third speech recognition machine-learning model. The decoding may be performed using a beam search algorithm. The beam width may be set to any suitable value, e.g. 20. The beam search algorithm may be a one-pass beam search algorithm. CTC score may be used in the beam search algorithm. The first transcription may be an N-best hypothesis generated by the decoding, e.g. the 1-best hypothesis.

Alternatively, the second transcription may be generated by the second speech recognition machine-learning model. The second transcription may be a different transcription than the first transcription that may be generated by decoding the unlabelled utterance using the second speech recognition machine-learning model. The second transcription may be an N-best hypothesis for a different N than the first transcription. For example, the first transcription may be the 1-best hypothesis and the second transcription may be the 2-best hypothesis. It should be noted that other N-best hypothesis could be used, e.g. the 1-best hypothesis may be used as the first transcription and the 3-best hypothesis may be used as the second transcription.

While the generation of a first transcription and a second transcription are described, it should be noted that further transcriptions may be generated and used. For example, further transcriptions may be generated by using one or more further speech recognition machine-learning models. As another example, further transcriptions may be generated by using an N-best hypothesis of the second machine-learning speech recognition model for values of N other than those used for the first transcription and the second transcription. Furthermore, the described techniques for generating multiple transcriptions may be combined, e.g. multiple N-best transcriptions may be generated using multiple speech recognition machine-learning models.

In step 240, the parameters of the first speech recognition machine-learning model are updated using the unlabelled utterance, the first transcription and the second transcription. Step 240 may include a processing step 242 and an updating step 244.

In the processing step 242, the unlabelled utterance is processed, by the first speech recognition machine-learning model, to derive posterior probabilities for the first transcription and the second transcription.

In the updating step 244, the parameters of the first speech recognition machine-learning model are updated in accordance with a loss function based on the derived posterior probabilities for the first transcription and the second transcription.

The parameters being updated may be weights, e.g. weights of a neural network where the first speech recognition machine-learning model is or includes a neural network.. The updating of the parameters may be performed by using a gradient descent method directed at minimising the loss function, e.g. stochastic gradient descent, in combination with a backpropagation algorithm.

The loss function may be a multiple hypotheses loss function, e.g. a loss function configured to derive a loss value using multiple hypotheses, such as transcriptions, for the contents of the utterance. The loss function may be a multiple hypothesis CTC loss function L*_{CTC}, which may be defined as follows:

$${L}_{CTC}^{*} = - ( {\sum }_{i = 1}^{N} log {P}_{θ} ( {\hat{C}}_{i} \vert X ) )$$

where Ĉᵢ, i=1, 2, . . . , N are 1^{st}, 2^{nd}, . . . , N^{th} transcriptions. N can be chosen based on the number of transcriptions used, e.g. where there is a first transcription and a second transcription but no further transcriptions, N may be two. The use of multiple transcriptions may alleviate the impact of errors in the transcriptions on the computation of the CTC loss function. Using the properties of the logarithm, the above equation can be rewritten as:

$${L}_{CTC}^{*} = - log {\prod }_{i = 1}^{N} {P}_{θ} ( {\hat{C}}_{i} \vert X ) - log {\prod }_{i = 1}^{N} ( {\sum }_{a ∈ {ℬ}^{- 1} ( {\hat{C}}_{i} )} {P}_{θ} ( {a}_{i} \vert X ) )$$

where aᵢ is a CTC path linking the transcription Ĉᵢ and the acoustic feature sequence X.

Where two transcriptions are used the above equation becomes:

$${L}_{CTC}^{*} = - log [ ( {\sum }_{{a}_{i} ∈ {ℬ}^{- 1} ( {\hat{C}}_{1} )} {P}_{θ} ( {a}_{i} \vert X ) ) ( {\sum }_{{b}_{j} ∈ {ℬ}^{- 1} ( {\hat{C}}_{2} )} {P}_{θ} ( {b}_{j} \vert X ) ) ]$$

where aᵢ and bⱼ are the ones of the CTC paths linking the transcriptions Ĉ₁ and Ĉ₂, respectively, with the acoustic feature sequence X. From this equation, it can be seen that a probability P_{θ}(aᵢ|X), computed by using the CTC path aᵢ would be multiplied with all the probabilities P_{θ}(bⱼ|X), bⱼ∈ [symbol] ⁻¹(Ĉ₂). This weighting, based on the probabilities computed from different CTC paths in [symbol] ⁻¹(Ĉ₂), could alleviate the impact of uncertainty in the CTC paths aᵢ∈ [symbol] ⁻¹(Ĉ₁), caused by transcripton errors in Ĉ₁, to the computation of the CTC loss L*_{CTC}.

Speech Recognition Machine-Learning Model Adaptation Using Labelled Utterances FIG. 3A is a flow diagram of a method 300A for adapting two speech recognition machine-learning models using labelled utterances in accordance with example embodiments. The example method may be implemented as one or more computer-executable instructions executed by one or more computing devices, e.g. the hardware 700 described in relation to FIG. 7.

In step 310, one or more labelled utterances having the one or more attributes are received. Each of the one or more labelled utterances includes an utterance and a respective transcription of the utterance. The respective transcription may include one or more characters. The one or more attributes may include any or any combination of the attributes described above in relation to step 210 of method 200.

In step 320, features of a first type are derived from the one or more labelled utterances. The features of the first type may be acoustic features. The acoustic features may be filter-bank features. For example, the acoustic features may be 40-dimensional log-Mel filter-bank (FBANK) features. The FBANK features may be augmented with 3 dimensional pitch features. Delta and acceleration features may be appended to these features. Alternatively, the acoustic features may be subband temporal envelope features (STE) features, e.g. 40-dimensional STE features. The STE features may be augmented with 3-dimensional pitch features. Delta and acceleration features may be appended to the STE features.

In step 330, parameters of a second speech recognition machine-learning model are updated using the derived features of the first type and the labels of the one or more labelled utterances.

The second speech recognition machine-learning model may be configured to receive features of the first type. The second speech recognition machine-learning model may be of any of the types described in relation to the first speech recognition machine-learning model of method 200. The second speech recognition machine-learning model may be configured to receive features of the first type, e.g. FBANK features. The second speech recognition machine-learning model have been trained in the same manner and/or using the same training data as the first speech recognition machine-learning model of method 200.

The parameters of the second speech recognition machine-learning model may be weights, e.g. where the second speech recognition machine-learning model is a neural network. The parameters may be updated in accordance with a loss function based on posterior probabilities derived by the second speech recognition machine-learning model for the respective transcription for each utterance of the one or more labelled utterances having the one or more attributes. The updating of the parameters may be performed by using a gradient descent method directed at minimising the loss function, e.g. stochastic gradient descent, in combination with a backpropagation algorithm. The loss function may be the CTC loss function or may be another suitable loss function, such as a cross entropy loss function.

In step 340, features of a second type are derived from the one or more labelled utterances. The features of a second type may be acoustic features. The second type may be any of the types described in relation to the first type, but is a different type to the first type. For example, if the first type of features are FBANK features then the second type of features may be STE features, or vice versa.

In step 350, parameters of a third speech recognition machine-learning model are updated using the derived features of the second type and the labels of the one or more labelled utterances.

The third speech recognition machine-learning model may be of any of the types described in relation to the first speech recognition machine-learning model of method 200. The second speech recognition machine-learning model may be configured to receive features of the second type, e.g. STE features. The third speech recognition machine-learning model have been trained in the same manner and/or using the same training data as the first speech recognition machine-learning model of method 200.

The parameters of the third speech recognition machine-learning model may be updated in the same or a similar way to that described in relation to the updating of the parameters of the second speech recognition machine-learning model in step 330.

FIG. 3B is a flow diagram of a method 300B for adapting the first speech recognition machine-learning model using labelled utterances in accordance with example embodiments. The example method may be implemented as one or more computer-executable instructions executed by one or more computing devices, e.g. the hardware 700 described in relation to FIG. 7.

In step 310, one or more labelled utterances having the one or more attributes are received.

In step 360, the parameters of the first speech recognition machine-learning model are updated using the one or more labelled utterances. The parameters of the first speech recognition machine-learning model may be updated in the same or a similar way to that described in relation to the updating of the parameters of the second speech recognition machine-learning model in step 330 of method 3A.

### Speech Recognition Method

FIG. 4 is a flow diagram of a method 400 for performing speech recognition in accordance with example embodiments. The example method may be implemented as one or more computer-executable instructions executed by one or more computing devices, e.g. the hardware 700 described in relation to FIG. 7.

In step 410, one or more utterances having the one or more attributes are received. The one or more attributes may include any or any combination of the attributes described above in relation to step 210 of method 200.

In step 420, the content of the one or more utterances is recognised using a speech recognition machine-learning model adapted to utterances having the one or more attributes. The speech recognition machine-learning model may have been adapted to utterances having the one or more attributes using the method 200 and/or the method 300B. Recognising the content may include decoding the one or more utterances using the speech recognition machine-learning model. The decoding may be performed using a beam search algorithm. The beam width may be set to any suitable value, e.g. 20. The beam search algorithm may be a one-pass beam search algorithm. CTC score may be used in the beam search algorithm. The result of the decoding may be a transcription of the one or more utterances. The transcription of the one or more utterances may be the textual content of the one or more utterances. Alternatively or additionally, the speech recognition machine-learning model may recognise semantic content, expression content, and/or other non-textual content of the one or more utterances.

In step 430, a function is executed based on the recognised content. Executing the function includes at least one of command performance, text output and/or spoken dialogue system functionality. Examples and implementations of command performance are described in relation to FIG. 1A and FIG. 1C. Examples and implementations of text output are described in relation to FIG. 1B and FIG. 1D.

A spoken dialogue system is a system that is able to converse with a user. In addition to performing speech recognition, examples of spoken dialogue system functionality include: natural language understanding functionality, e.g. functionality that can infer conceptual and/or semantic content from the recognised content of the one or more utterances; dialogue management functionality, which structures the conversation with the user, e.g. can direct the conversation based on the recognised and/or inferred content of the one or more utterances, and/or one or more previous utterances; domain reasoning or backend functionality, which retrieves information, e.g. from a data store or the Internet, for use in generating a response to the content of the one or more utterances; and response generation functionality, which generates a response based on the content of the one or more utterances, the information retrieved, state of the dialogue manager, and/or inferred conceptual and/or semantic content; and/or include text-to-speech functionality for transforming the generated response, which may be generated as text or tokens, into spoken audio.

### System for Supervised Adaptation of Speech Recognition Machine-Learning Models

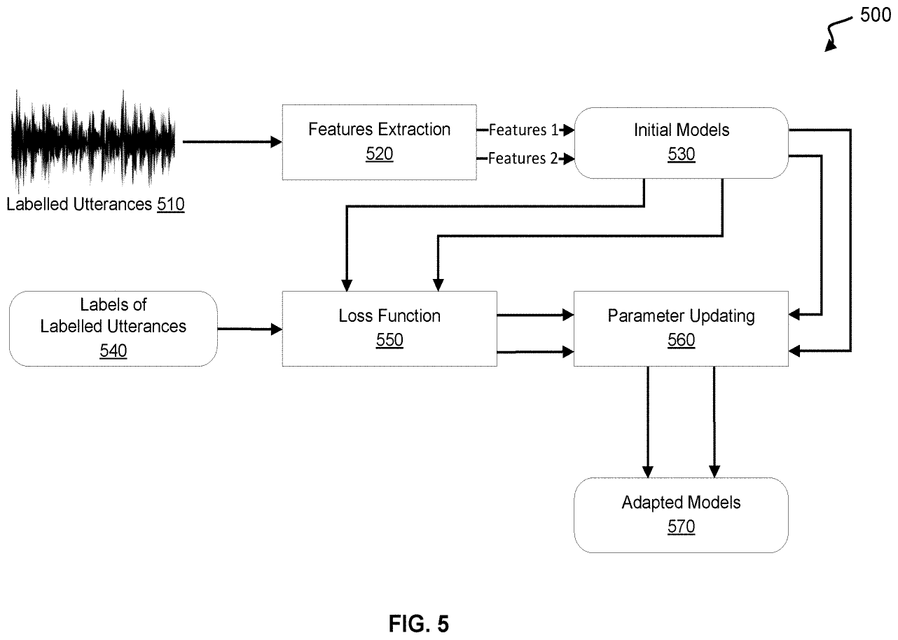

FIG. 5 is a schematic block diagram of a system 500 for supervised adaptation of speech recognition machine-learning models in accordance with example embodiments. The system 500 may be implemented using one or more computer-executable instructions on one or more computing devices, e.g. the hardware 700 described in relation to FIG. 7.

The system performs the supervised adaptation using one or more labelled utterances 510 and the labels 540, e.g. transcriptions, of the one or more labelled utterances. The one or more labelled utterances 510 are utterances having one or more attributes.

The system includes a features extraction module 520 which extracts features of a first type, Features 1, and features of a second type, Features 2, from the one or more labelled utterances 510. The features of the first type may be FBANK features and the features of the second type may be STE features.

The system 500 includes initial speech recognition machine-learning models 530. There are at least two initial speech recognition machine-learning models 530. At least one of the initial speech recognition machine-learning models 530 receives the features of the first type, Features 1, and at least one other of the initial speech recognition machine-learning models 530 receives the features of the second type, Features 2. The speech recognition machine-learning models are usable to derive posterior probabilities for labels, e.g. transcriptions, of the one or more utterances. For example, the speech recognition machine-learning model may output a probability vector in response to receiving features of the respective type with the probability vector indicating the likelihood of different transcriptions or labels of those features, e.g. the probability that the received features correspond to a given character.

The system 500 includes a loss function module 550. The loss function module 550 receives the labels 540 of the one or more labelled utterances and the outputs of the initial speech recognition machine-learning models 530. The loss function module 550 utilises these to calculate a respective loss value for each of the initial speech recognition machine-learning models 530. The loss function module may calculate the respective loss values using the CTC loss function or another suitable loss function, e.g. a cross-entropy loss function.

The system 500 includes a parameter updating module 560. The parameter updating module 560 receives the initial speech recognition machine-learning models 530 and the respective loss values from the loss function module 550. The parameter updating module 560 updates the parameters of each of the initial speech recognition machine-learning models 530 in accordance with the corresponding loss value.

The results of the parameter updating are adapted speech recognition machine-learning models 570 which are adapted to utterances having the one or more attributes.

### System for Semi-Supervised Speech Recognition Machine-Learning Model Adaptation

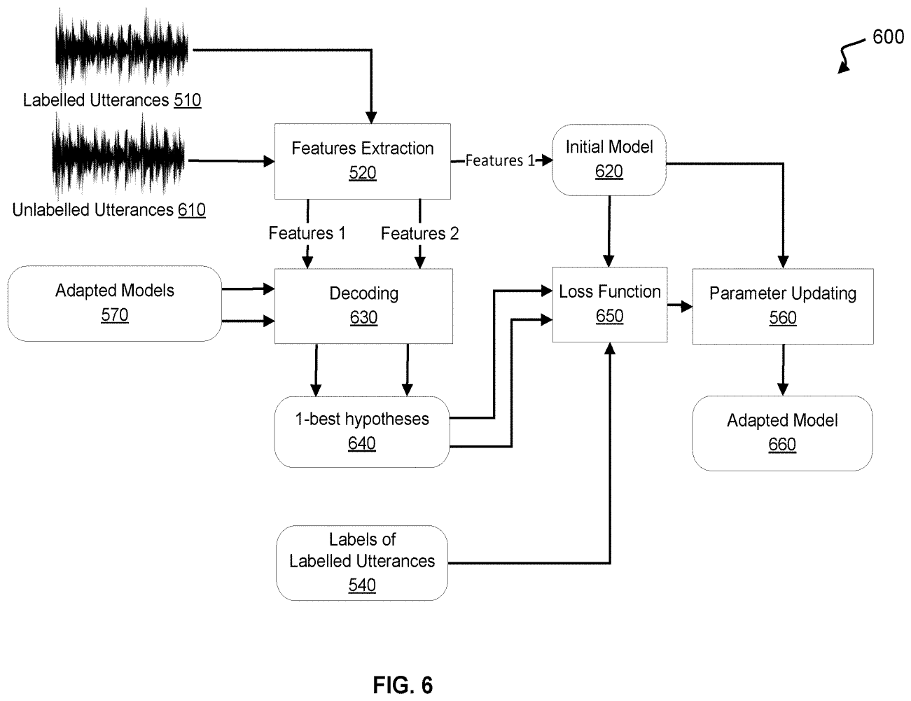

FIG. 6 is a schematic block diagram of a system for semi-supervised adaptation of a speech recognition machine-learning model in accordance with example embodiments. The system 600 may be implemented using one or more computer-executable instructions on one or more computing devices, e.g. the hardware 700 described in relation to FIG. 7.

The system 600 performs the semi-supervised adaptation using one or more labelled utterances 510, the labels 540, e.g. transcriptions, of the one or more labelled utterances, and one or more unlabelled utterances 610.

The system 600 includes a features extraction module 520 which extracts features of a first type, Features 1, and features of a second type, Features 2, from the one or more labelled utterances 510 and the one or more unlabelled utterances 610. The features of the first type may be FBANK features and the features of the second type may be STE features.

The system 600 includes an initial speech recognition machine-learning model 620. The initial speech recognition machine-learning model 620 receives extracted features of the first type for both the labelled utterances 510 and the unlabelled utterances 620.

The decoding module 630 generates transcriptions from the extracted features of the first type and the extracted features of the second type using the corresponding adapted speech recognition machine-learning models 570. In other words, the decoding module 630 determines a first transcription of the one or more unlabelled utterances which is estimated to be most likely from the features of the first type by model of the adapted speech recognition machine-learning models 570 that receives such features, and also determines a second transcription of the one or more unlabelled utterances which is estimated to be most likely from the features of the second type by the model of the adapted speech recognition machine-learning models 570 that receives such features. The first transcription and the second transcription are the 1-best hypotheses 640.

The system 600 includes a loss function module 650. For the labelled utterances, the loss function module 550 receives the labels 540 of the one or more labelled utterances and the corresponding outputs of the initial speech recognition machine-learning model 620. The loss function module 650 utilises these to calculate a respective loss value. For the unlabelled utterances, the loss function module receives the 1-best hypotheses and the corresponding outputs of the initial speech recognition machine-learning model 620. The loss function module 650 utilises these to calculate a respective loss value. The loss function module 650 implements a multiple hypotheses loss function which is used to calculate the respective loss value. The multiple hypotheses loss function may be the multiple hypotheses CTC loss function, L*_{CTC}, previously described. The multiple hypotheses loss function is used for both the labelled utterances and the unlabelled utterances. For the unlabelled utterances, the multiple hypotheses are the 1-best hypotheses, e.g. the 1-best hypotheses for each of the adapted models 570. For the labelled utterances, a multiple hypotheses loss function is used but each of the hypotheses are the same and are the labels 540 of the labelled utterances. In other words, a loss function that works with multiple hypotheses is used when calculating the loss value for the labelled utterances, but as the single correct hypothesis is known, e.g. the labels, this single hypothesis is used for all hypotheses used by the loss function. This is beneficial as it means that a single loss function can be used for both unlabelled and labelled utterances.

The parameter updating module 560 receives the initial speech recognition machine-learning model 620 and the loss values from the loss function module 650. The parameter updating module 560 updates the parameters of the initial speech recognition machine-learning models 620 in accordance with the loss value.

The results of the parameter updating is the adapted speech recognition machine-learning model 660 which is adapted to utterances having the one or more attributes.

### Computing Hardware

FIG. 7 is a schematic of the hardware that can be used to implement methods in accordance with embodiments. It should be noted that this is just one example and other arrangements can be used.

The hardware comprises a computing section 700. In this particular example, the components of this section will be described together. However, it will be appreciated that they are not necessarily co-located.

Components of the computing system 700 may include, but not limited to, a processing unit 713 (such as central processing unit, CPU), a system memory 701, a system bus 711 that couples various system components including the system memory 701 to the processing unit 713. The system bus 711 may be any of several types of bus structure including a memory bus or memory controller, a peripheral bus and a local bus using any of a variety of bus architecture etc. The computing section 700 also includes external memory 715 connected to the bus 711.

The system memory 701 includes computer storage media in the form of volatile/or non-volatile memory such as read-only memory. A basic input output system (BIOS) 703 containing the routines that help transfer information between the elements within the computer, such as during start-up is typically stored in system memory 701. In addition, the system memory contains the operating system 705, application programs 707 and program data 709 that are in use by the CPU 713.

Also, interface 725 is connected to the bus 711. The interface may be a network interface for the computer system to receive information from further devices. The interface may also be a user interface that allows a user to respond to certain commands et cetera.

In this example, a video interface 717 is provided. The video interface 717 comprises a graphics processing unit 719 which is connected to a graphics processing memory 721.

Graphics processing unit (GPU) 719 is particularly well suited to adapting a speech recognition machine-learning model due to its adaptation to data parallel operations, such as neural network adaptation. Therefore, in an embodiment, the processing for adapting a speech recognition machine-learning model may be divided between CPU 713 and GPU 719.

It should be noted that in some embodiments different hardware may be used for the adapting the speech recognition machine-learning model and for performing speech recognition. For example, the adaptation of the speech recognition machine-learning model may occur on one or more local desktop or workstation computers or on devices of a cloud computing system, which may include one or more discrete desktop or workstation GPUs, one or more discrete desktop or workstation CPUs, e.g. processors having a PC-oriented architecture, and a substantial amount of volatile system memory, e.g. 16 GB or more. While, for example, the performance of speech recognition may use mobile or embedded hardware, which may include a mobile GPU as part of a system on a chip (SoC) or no GPU; one or more mobile or embedded CPUs, e.g. processors having a mobile-oriented architecture, or a microcontroller-oriented architecture, and a lesser amount of volatile memory, e.g. less than 1 GB. For example, the hardware performing speech recognition may be a voice assistant system 120, such as a mobile phone including a virtual assistant or a smart speaker. The hardware used for adapting the speech recognition machine-learning model may have significantly more computational power, e.g. be able to perform more operations per second and have more memory, than the hardware used for performing tasks using the agent. Using hardware having lesser resources is possible because performing speech recognition, e.g. by performing inference using one or more neural networks, is substantially less computationally resource intensive than adapting the speech recognition machine-learning models, e.g. by updating parameters of one or more neural networks. Furthermore, techniques can be employed to reduce the computational resources used for performing speech recognition, e.g. for performing inference using one or more neural networks. Examples of such techniques include model distillation and, for neural networks, neural network compression techniques, such as pruning and quantization.

In some embodiments, the same hardware may be used for adapting the speech recognition machine-learning model for performing speech recognition. Adaptation of a speech recognition machine-learning model may be performed using a relatively small amount of data compared with initial training of the speech recognition machine-learning model, thus easier to perform on mobile or embedded hardware being used for speech recognition. Performing adaptation on mobile or embedded hardware may be particularly advantageous where the utterances used for adaptation are sensitive, e.g. confidential, or private, as performing the adaptation on the mobile or embedded hardware used for speech recognition itself avoids transmission of these sensitive utterances to an external computing device, e.g. a server of a cloud computing system. Thus, adaptation of speech recognition machine-learning models to utterances having attributes associated with such sensitive information can be performed without compromising privacy, security, or confidentiality. For example, a speech recognition machine-learning model may be adapted to a user's voice based on private utterances by a user, or to the background noise in a company's office based on utterances that may contain confidential commercially sensitive information. Performing adaptation on mobile or embedded hardware also allows adaptation to be performed offline, e.g. without an internet connection or other type of connection to another computer, and, even where such a connection is available, reduces the network resources that would otherwise be used by the mobile or embedded hardware to send utterances to the another computer and to receive the adapted model.

### Experiments

Experiments performed to assess the effectiveness of semi-supervised adaptation of the speech recognition machine-learning models are presented below.

In the experiments described below, each of the speech recognition machine-learning models is a neural network architecture having a VGG net architecture (deep CNN) followed by a 6-layer pyramid BLSTM (BLSTM with subsampling). The 6-layer CNN architecture has two consecutive 2D convolutional layers followed by one 2D max-pooling layer, then another two 2D convolutional layers followed by one 2D max-pooling layer. The 2D filters used in the convolutional layers have the same size of 3×3. The max-pooling layers have patch of 3×3 and stride of 2×2. The 6-layer BLSTM has 1024 memory blocks in each layer and direction, and linear projection is followed by each BLSTM layer. The subsampling factor performed by the BLSTM is 4. When these speech recognition machine-learning models are used in decoding, a one-pass beam search algorithm using the CTC score is performed, with the beam width set to 20.

Experiments were performed on both speech recognition machine-learning models trained using clean training data and speech recognition machine-learning models trained using multi-condition training data.

The clean training data used in the experiments was from the WSJ corpus which is a corpus of read speech. All the speech utterances in the corpus are sampled at 16 kHz and are fairly clean. The WSJ's standard training set train_si284 consists of around 81 hours of speech. During training, the standard development set test_dev93, which consists of around 1 hour of speech, was used for cross-validation.

The multi-condition training data was from the CHiME-4 corpus which consists of around 189 hours of speech, in total. The CHiME-4 multi-condition training data consists of the clean speech utterances from WSJ training corpus and simulated and real noisy data. The real data consists of 6-channel recordings of utterances from WSJ corpus spoken in four environments: café, street junction, public transport (bus), and pedestrian area. The simulated data was constructed by mixing WSJ clean utterances with the environment background recordings from the four mentioned environments. All the data were sampled at 16 kHz. Audio recorded from all the microphone channels are included in the CHiME-4 multi-condition training data. The dt05_multi isolated_1ch_track set was used for cross-validation during training.

The test and adaptation data for the experiments were created from the tests set of the Aurora-4 corpus. The Aurora-4 corpus has 14 test sets which were created by corrupting two clean test sets, recorded by a primary microphone and a secondary microphone, with six types of noises: airport, babble, car, restaurant, street, and train, at 5-15 dB SNRs. The two clean test sets were also included in the 14 test sets. There are 330 utterances in each test set. The noises in Aurora-4 are different from those in the CHiME-4 multi-condition training data. The .wv1 data from 7 test sets created from the clean test set recorded by the primary microphone are used to create test and adaptation sets. From 2310 utterances taken from the 7 test sets of .wv1 data, a test set of 1400 utterances (approx. 2.8 hours of speech), a labelled adaptation set of 300 utterances (approx. 36 minutes), and an unlabelled adaptation set of 610 utterances (approx. 1.2 hours) are separated. The selection of the utterances in the three sets are random. The utterances in the three sets are not overlapped. These sets are used for testing and adaptation in both clean training and multi-condition training scenarios.

For both the experiments with clean training data and the multi-condition training data, the semi-supervised adaptation was performed as follows.

[symbol] _{FB} and [symbol] _{STE} denote end-to-end models trained with FBANK and STE features, respectively.

First, the backpropagation algorithm is used to fine-tune, e.g. update the parameters of, the models [symbol] _{FB} and [symbol] _{STE} in supervised mode using the labelled adaptation set of 300 utterances to obtain the adapted models [symbol] _{FB} and [symbol] _{STE}, respectively. This is done to utilize the available labelled adaptation to further reduce the word error rates (WERs) of the speech recognition machine-learning models.

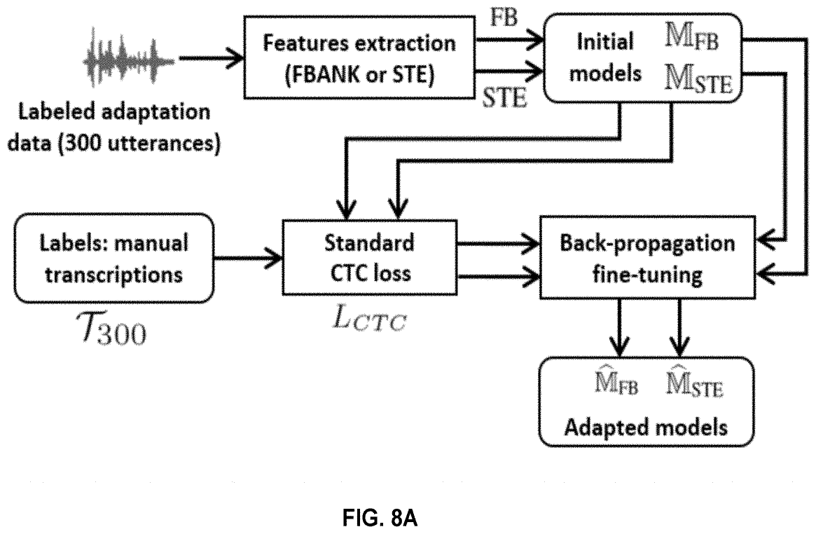

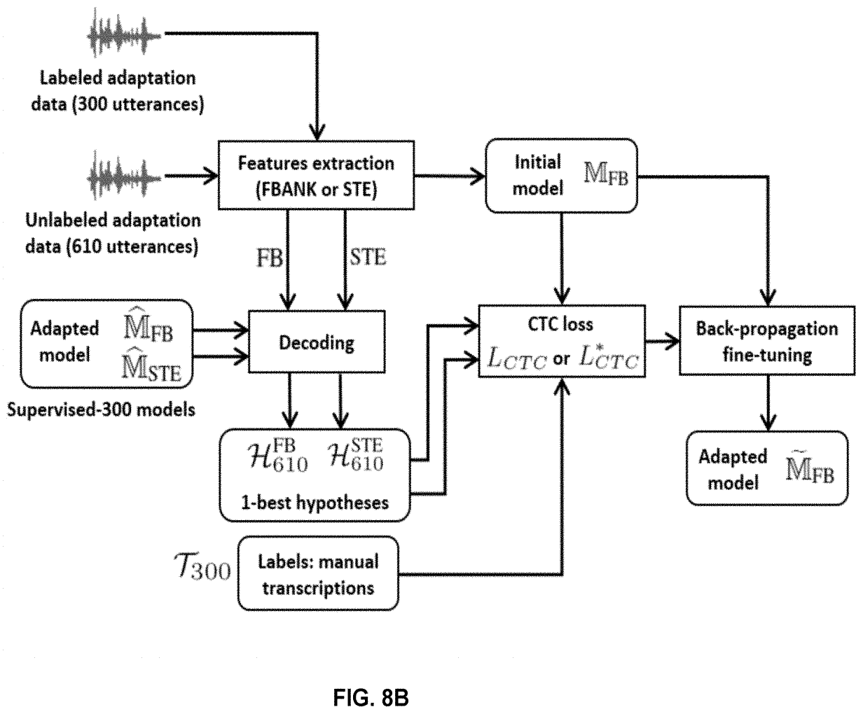

This is illustrated in FIG. 8A which shows the supervised adaptation of initial models [symbol] _{FB} and [symbol] _{STE} using the 300-utterance set with manual transcriptions [symbol] ₃₀₀.

The models [symbol] _{FB} and [symbol] _{STE} are subsequently used to decode the unlabelled adaptation set of 610 utterances. Assume that [symbol] ₆₁₀^{FB} and [symbol] ₆₁₀^{STE} are the sets of 1-best hypotheses obtained from these decodings and [symbol] ₃₀₀ is the set of manual transcriptions available for the 300 utterances set, the 300-utterance and 610-utterance sets are grouped to create an adaptation set of 910 utterances whose labels could be either [symbol] ₃₀₀∪ [symbol] ₆₁₀^{FB} or [symbol] ₃₀₀∪ [symbol] ₆₁₀^{STE}.

Finally, the 910-utterance set is used to adapt the model [symbol] _{FB}, which is the baseline model, using the backpropagation algorithm to obtain the semi-supervised adapted model [symbol] _{FB}.

The 910-utterance adaptation set in which 610 utterances do not have manual transcriptions is used to adapt the initial FBANK based model in semi-supervised mode since only 300 utterances have manual transcriptions. The conventional semi-supervised adaptation using the 910-utterance adaptation set can be done with the labels from [symbol] ₃₀₀ and, either [symbol] ₆₁₀^{FB} or [symbol] ₆₁₀^{STE}. This adaptation uses the standard CTC loss L_{CTC}. The multiple-hypotheses CTC-based adaptation method described herein, which is denoted as MH-CTC, uses the [symbol] ₃₀₀ manual transcriptions and both sets of 1-best hypotheses, [symbol] ₆₁₀^{FB} and [symbol] ₆₁₀^{STE}. This adaptation uses the L*_{CTC} loss.

This is illustrated in FIG. 8B which shows semi-supervised adaptations using the 910-utterance adaptation set, of which the labels include the manual transcriptions [symbol] ₃₀₀, and one of the sets of 1-best hypotheses, [symbol] ₆₁₀^{FB} and [symbol] ₆₁₀^{STE}, or both.

The referenced performance which can be considered as an upper bound performance for all the mentioned adaptation methods is that obtained with the supervised adaptation where all 910 utterances have manual transcriptions [symbol] ₉₁₀. During adapation, the learning rate is kept unchanged compared to that used during training because this configuration yields better performance than using different learning rates during training and adaptation. The 1-best hypotheses are obtained after one pass of decoding.

### Results

In the scenario where the systems are trained on the WSJ clean training data and tested on the test set consisting of 1400 Auror-4 utterances, the initial systems which used the models [symbol] _{FB} and [symbol] _{STE}, respectively have WERs of 55.2% and 60.3%, respectively.

The results of applying different adaptation methods to the FBANK-based model are shown in the table below. The table shows results for adaptation of the FBANK-based model trained on the WSJ clean training set with different adaptation methods. [symbol] ₆₁₀^{FB-C} and [symbol] ₆₁₀^{FB-STE} are obtained in the decoding using clean training models.

| Adaptation method | # Utts. | Adapt. data’s labels | WER |
|---|---|---|---|
| No adapt. (initial model) | N/A | N/A | 55.2 |
| Supervised-300 (baseline) | 300 | [symbol] ₃₀₀ | 27.2 |
| Semi-supervised-FB | 910 | [symbol] ₃₀₀ ∪ [symbol] ₆₁₀^{FB-C} | 28.4 |
| Semi-supervised-STE | 910 | [symbol] ₃₀₀ ∪ [symbol] ₆₁₀^{STE-C} | 27.4 |
| MH-CTC (proposed) | 910 | [symbol] ₃₀₀ ∪ [symbol] ₆₁₀^{FB-C} ∪ | 25.4 |
| | | [symbol] ₆₁₀^{STE-C} | |
| Supervised-910 | 910 | [symbol] ₉₁₀ | 13.2 |

Adapting the initial FBANK-based and STE-based models with the labelled adaptation set of 300 utterances reduces the WERs of these systems measured on the 1400-utterance test set to 27.2% and 24.5%, respectively. The corresponding WERs measured on the 610-utterance unlabelled adaptation set are 29.1% and 25.6%, respectively.

Supervised adaptation using the 300-utterance adaptation set with manual transcriptions [symbol] ₃₀₀ is used as the baseline. The multiple hypotheses CTC-based adaptation method yields 6.6% relative WER reduction compared to the baseline. In contrast, the two conventional semi-supervised adaptations which use both manual transcriptions and one of the sets of 1-best hypotheses, [symbol] ₆₁₀^{FB-C} and [symbol] ₆₁₀^{STE-C}, do not yield WER reduction compared to the FBANK-based baseline model.

The above experiments are also performed for the multi-condition training data scenario. When being trained on the multi-condition training data of CHiME-4 and tested on the 1400-utterance test set from Aurora-4, the initial CTC-based end-to-end ASR systems using FBANK and STE features have WERs of 31.0% and 33.8%, respectively. Adapting the initial FBANK-based and STE-based models with the labelled adaptation set of 300 utterances reduces the WERs of these systems measured on the 1400-utterance test set to 17.2% and 17.3%, respectively. The corresponding WERs which are measured on the 610-utterance unlabelled adaptation set are 18.3% and 18.9%, respectively.

The results of applying the adaptation method in the multi-condition training data scenario are shown in the table below. The table shows results for the adaptation of the FBANK-based model trained on the CHiME-4 multi-condition training set with different adaptation methods. [symbol] ₆₁₀^{FB-M} and [symbol] ₆₁₀^{STE-M} are obtained in the decoding using multi-condition training models.

| Adaptation method | # Utts. | Adapt. data’s labels | WER |
|---|---|---|---|
| No adapt. (initial model) | N/A | N/A | 31.0 |
| Supervised-300 (baseline) | 300 | [symbol] ₃₀₀ | 17.2 |
| Semi-supervised-FB | 910 | [symbol] ₃₀₀ ∪ [symbol] ₆₁₀^{FB-M} | 17.7 |
| Semi-supervised-STE | 910 | [symbol] ₃₀₀ ∪ [symbol] ₆₁₀^{STE-M} | 17.9 |
| MH-CTC (proposed) | 910 | [symbol] ₃₀₀ ∪ [symbol] ₆₁₀^{FB-M} ∪ | 16.2 |
| | | [symbol] ₆₁₀^{STE-M} | |
| Supervised-910 | 910 | [symbol] ₉₁₀ | 6.7 |

The multiple hypotheses CTC based method (MH-CTC) yields 5.8% relative WER reduction compared to the baseline. The semi-supervised adaptations using single 1-best hypotheses [symbol] ₆₁₀^{FB-M} or [symbol] ₆₁₀^{STE-M} do not yield WER reduction compared to the baseline.

### Variations

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A computer-implemented method for adapting a first speech recognition machine-learning model to utterances having one or more attributes comprising:
receiving an unlabelled utterance having the one or more attributes;
generating a first transcription of the unlabelled utterance;
generating a second transcription of the unlabelled utterance, wherein the second transcription is different from the first transcription;
processing, by the first speech recognition machine-learning model, the one or more unlabelled utterances to derive posterior probabilities for the first transcription and the second transcription; and
updating parameters of the first speech recognition machine-learning model in accordance with a loss function based on the derived posterior probabilities for the first transcription and the second transcription.

2. The method of claim 1, wherein the second transcription differs from the first transcription in that the first transcription is generated by a second speech recognition machine-learning model while the second transcription is generated by a different third speech recognition machine-learning model.

3. The method of claim 2, wherein the second speech recognition machine-learning model has been trained using a first type of features, and the third speech recognition machine-learning model has been trained using a different second type of features.

4. The method of claim 3, wherein the first type of features are filter-bank features.

5. The method of claim 3, wherein the second type of features are subband temporal envelope features.

6. The method of claim 3, wherein the first transcription is the 1 -best hypothesis of the second speech recognition machine-learning model and the second transcription is the 1 -best hypothesis of the third speech recognition machine-learning model.

7. The method of claim 3, further comprising:
receiving one or more labelled utterances having the one or more attributes;
deriving features of the first type from the one or more labelled utterances;
updating parameters of the second machine-learning model using the derived features of the first type and labels of the one or more labelled utterances;
deriving features of the second type from the one or more labelled utterances; and
updating parameters of the third machine-learning models using the derived features of the second type and the labels of the one or more labelled utterances.

8. The method of claim 1, wherein the first transcription and the second transcription are N-best transcriptions generated by a second speech recognition machine-learning model, and wherein the second transcription differs from the first transcription in that the second transcription is for a different value of N than the first transcription.

9. The method of claim 1, further comprising:
receiving one or more labelled utterances having the one or more attributes; and
updating the parameters of the first speech recognition machine-learning model using the one or more labelled utterances.

10. The method of claim 1, wherein the one or more attributes comprise the utterance having background noise of a given type.

11. The method of claim 1, wherein the one or more attributes comprise the utterance being in a given domain.

12. The method of claim 1, wherein the one or more attributes comprise the utterance being by a given user.

13. The method of claim 1, wherein the one or more attributes comprise the utterance being recorded in a given environment.

14. The method of claim 1, wherein the unlabelled utterances have been artificially modified to have the one or more attributes.

15. The method of claim 1, wherein the loss function is a connectionist temporal classification loss function.

16. The method of claim 15, wherein the connectionist temporal classification loss function comprises a sum of a first connectionist temporal classification loss for the first transcription by a second connectionist temporal classification loss for the second hypothesis.

17. The method of claim 1, wherein the first speech recognition machine-learning model comprises a bidirectional long short-term memory neural network.

18. A computer-implemented method for speech recognition comprising:
receiving one or more utterances having one or more attributes;
recognising content of the one or more utterances using a speech recognition machine-learning model adapted to utterances having the one or more attributes according to the method of claim 1; and
executing a function based on the recognised content, wherein the executed function comprises at least one of text output, command performance, or speech dialogue system functionality.

19. The method of claim 18, wherein the one or more attributes comprise the utterance having background noise of a given type.

20. A system for performing speech recognition, the system comprising one or more processors and one or more memories, the one or more processors being configured to:
receive one or more utterances having one or more attributes;
recognise content of the one or more utterances using a speech recognition machine-learning model adapted to utterances having the one or more attributes according to the method of claim 1; and
execute a function based on the recognising content, wherein the executed function comprises at least one of text output or command performance.
